(19) United States
(12) Patent Application Publication
(10) Pub. No.: US 2007/0139562 A1
(43) Pub. Date: Jun. 21, 2007

(54) Color image display apparatus

(75) Inventor: Yasunari Miyake, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/643,095

(22) Filed: Dec. 21, 2006

(30) Foreign Application Priority Data
Dec. 21, 2005 (JP) 2005-368518

(51) Int. Cl. H04N 5/58

(52) U.S. Cl. 348/603

(57) ABSTRACT

A color image display apparatus to adjust a display color of a color image in accordance with a viewer is provided. A television as one embodiment of the color image display apparatus includes a camera that shoots an object and outputs an image signal, an image processing unit that extracts a preset area and calculates a color temperature around the object on the basis of image data corresponding to the area, a video source that receives an input of a video signal, a combining circuit that generates a video signal on the basis of the color temperature calculated by the image processing unit and the video source, and a video display unit that displays a video image on the basis of the video signal.

### BACKGROUND OF THE INVENTION

1. Field of the Invention

The present invention relates to a color image display apparatus and, in particular, to a color image display apparatus that can adjust display video colors in accordance with viewers.

2. Description of the Background Art

A color television, a color display apparatus, and other color image display apparatuses display a color image on the basis of a prescribed set value. In many cases, the color image display apparatus changes color display operation of a color image on the basis of a user's setting. The setting for changing the color display operation by the user can be troublesome and, the setting for displaying user's desiring color cannot be realized. Therefore, the convenience of the color image display apparatuses is not necessarily acceptable to viewers.

In order to offer the convenience to the viewer, for example, Japanese Patent Laying-Open Nos. 2003-078920, 2002-323382, and 2002-091415 disclose a display apparatus that can adjust a color temperature in accordance with a lighting environment. Further, Japanese Patent Laying-Open No. 09-247564 discloses a television receiver that improves the convenience not only in view of image display operation but also in. view of sound replay. Furthermore, Japanese Patent Laying-Open No.2005-236353 discloses a receiving apparatus that offers the convenience to the viewer in view of program recommendation.

With respect to television watching, a television set at a living room can be used not only by one specific person but also by another family member.

With the display apparatus disclosed in Japanese Patent Laying-Open No. 2003-078920, a specific viewer sets a color temperature and the display apparatus displays a video image on the basis of the set value of the color temperature. In this case, a favorite color of another viewer cannot be displayed. The other viewer cannot necessarily be satisfied with the convenience of the display apparatus.

### SUMMARY OF THE INVENTION

The present invention is devised to solve the above problems. It is one object of the present invention to provide a color image display apparatus that can display color images in accordance with a plurality of viewers.

It is another object of the present invention to provide a color image display apparatus that can adjust and display a color image to a specific viewer.

In summary, in order to accomplish the objects, according to one aspect of the present invention, a color image display apparatus comprises: a tuner that obtains a video signal for displaying a color image; a display that displays the color image at a display area on the basis of the video signal; a camera that shoots an object and obtains image data corresponding to an image of the object; and a memory that stores a first characteristics amount obtained in advance for a first viewer of the color image display apparatus, and a set value input in advance so as to display a color image to the first viewer. The first amount of characteristics is associated with the set value. The color image display apparatus further comprises: a shooting control circuit that causes the camera to execute shooting operation on the basis of the video image displayed at the display area; a characteristic-amount calculating circuit that performs image analysis processing preset to image data of a second viewer, obtained on the basis of the shooting operation, and calculates the second viewer's characteristics amount, a determining circuit that determines whether or not the second viewer is the first viewer by comparing the first viewer's characteristics amount with the second viewer's characteristics amount; an extracting circuit that extracts partial image data corresponding to a partial area within a shootable range of the camera from the image data obtained by the camera; a calculating circuit that calculates the total of color components forming an image corresponding to the partial image on the basis of the partial image data; a color temperature determining circuit that determines a color temperature on the basis of the total of color elements; and an element changing circuit that changes color elements forming a video image displayed at the display area on the basis of the color temperature and the set value.

Further, according to another aspect of the present invention, a color image display apparatus comprises: an obtaining unit that obtains a video signal for displaying a color image; a display unit that displays the color image at a display area on the basis of the video image signal; an image pickup unit that shoots an object and obtains image data corresponding to an image of the object; a storage unit that stores specific data prepared in advance so as to specify a first viewer of the color image display apparatus and a set value input in advance so as to display a color image of the first viewer. The specific data is associated with the set value. The color image display apparatus further comprises: an image obtaining unit that obtains an image of a second viewer who views the video image on the basis of the video image displayed at the display area; a determining unit that determines whether or not the second viewer is the first viewer on the basis of the specific data and the second viewer's image; and a control unit that controls display of the video image at the display area by adjusting a display color of the video image displayed at the display area on the basis of the set value corresponding to the first viewer, when the determining unit determines that the second viewer is the first viewer.

Furthermore, according to another aspect of the present invention, a color image display apparatus comprises: an interface that obtains a video signal for displaying a color image; a display device that displays the color image in the display area on the basis of the video signal; a camera that shoots an object and obtains image data corresponding to an image of the object; a memory that stores specific data prepared in advance so as to specify a first viewer of the color image display apparatus, a set value input in advance so as to display a color image to the first viewer, and an instruction sequence. The specific data is associated with the set value. The color image display apparatus further comprises a processor that executes the instruction sequence. The instruction sequence comprises: an image obtaining step of obtaining an image of a second viewer who views the video image on the basis of display operation of the video image at the display area; a determining step that determines whether or not the second viewer is the first viewer on the basis of the specific data and the image of the second viewer; and a control step of controlling the display operation of the video image at the display area by adjusting a display color of the video image displayed at the display area on the basis of the set value associated with the first viewer, when it is determined that the second viewer is the first viewer.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the structure of a color image display apparatus according to an embodiment of the present invention.

FIG. 2 is a diagram showing the disposing situation of a television at a room.

FIG. 3 is a front view showing the television.

FIG. 4 is a block diagram showing the structure of a function for realizing the television.

FIG. 5 is a block diagram showing the hardware structure of the television.

FIG. 6 is a diagram conceptually illustrating an example of data storage in a memory in the television.

FIG. 7 is a diagram conceptually illustrating an example of data processing of a CPU.

FIG. 8 is a diagram showing a relationship -between a color temperature at the disposing place of the television and a color temperature that is input in advance as a set value.

FIG. 9 is a diagram conceptually showing a face image stored in the memory.

FIG. 10 is a to view showing the room at which the television is disposed.

FIG. 11 is a flowchart showing a processing sequence to first identify a viewer, executed by a CPU.

FIG. 12 is a flowchart showing a processing sequence to display images in accordance with viewers, executed by the CPU.

### DESCRIPTION OF THE PREFERRED EMBODIMENTS

Hereinbelow, an embodiment of the present invention will be described with reference to the drawings. In the following description, the same reference numerals denote the same parts with the same functions. Therefore, a specific description thereof is not repeated.

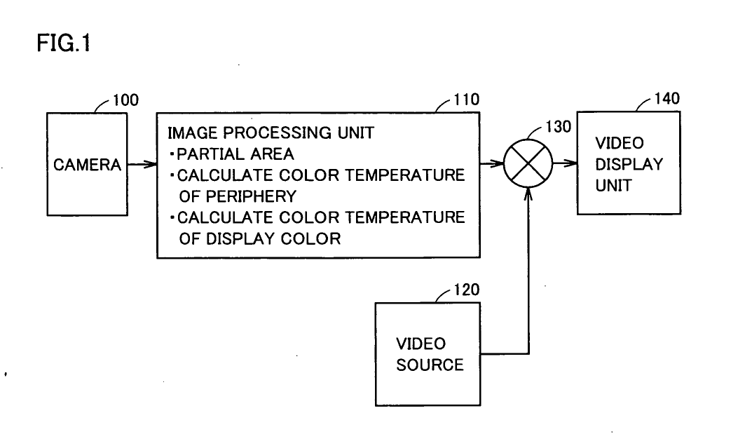

First, with reference to FIG. 1 the technical idea of the present invention will be described. FIG. 1 is a diagram showing the structure of a color image display apparatus according to the present invention. The color image display apparatus comprises: a camera 100; an image processing unit 110; a video source 120; a combining circuit 130; and a video display unit 140. The color image display apparatus is realized as a television receiving apparatus, a display apparatus connected to a computer, or the like.

Camera 100 shoots an object and outputs an image signal. The image signal is input to image processing unit 110. Image processing unit 110 extracts a preset area and calculates a color temperature around the object on the basis of image data corresponding to the area. Further, image processing unit 110 calculates the color temperature displayed on video display unit 140 on the basis of the color temperature and preset information. Video source 120 is a television broadcasting signal or a video signal that is recorded in advance to a data recording medium. If the color image display apparatus is connected to a network, video source 120 may be a video signal input via the network.

Combining circuit 130 generates a video signal to display an image on video display unit 140 on the basis of the color temperature calculated by image processing unit 110 and video source 120. The generated signal is sent to video display unit 140. Video display unit 140 displays an image on the basis of the signal. The above-displayed video image reflects the color temperature around the object shot by camera 100.

The color image display apparatus can be realized by a color television having a camera, alternatively, a display apparatus that receives an input of the image signal and displays the image. Hereinbelow, a television 200 will be described as one example of the color image display apparatus.

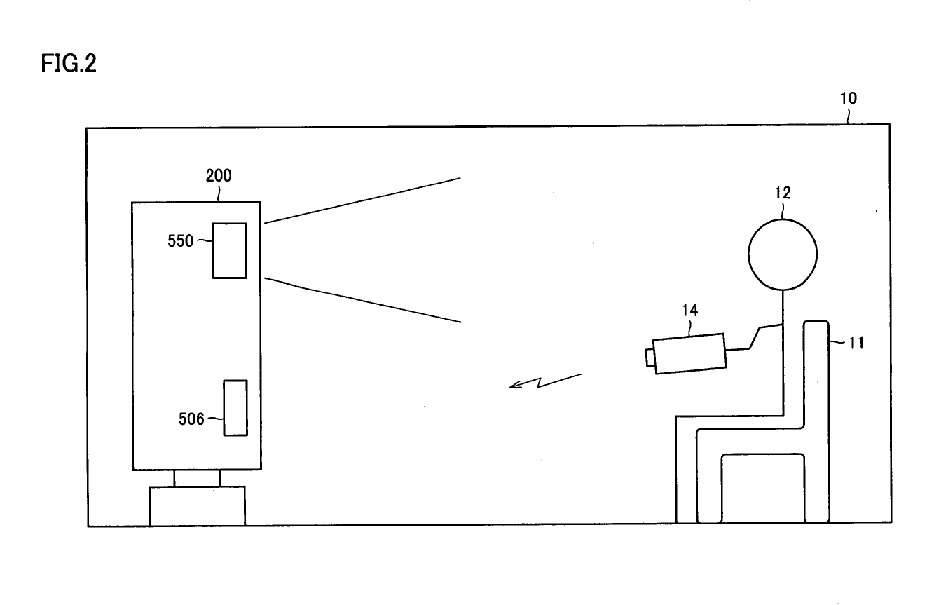

FIG. 2 is a diagram showing the setting situation of television 200 at room 10. At room 10, television 200 and chair 11 are arranged. A viewer 12 sits on chair 11. Viewer 12 has a remote control terminal 14. Television 200 comprises a camera 550 and a light receiving unit 506 that receives a remote control signal. A positional relationship between camera 550 and chair 11 is determined on the basis of a shootable range of, e.g., camera 550. Preferably, chair 11 is set on the central line of camera 550.

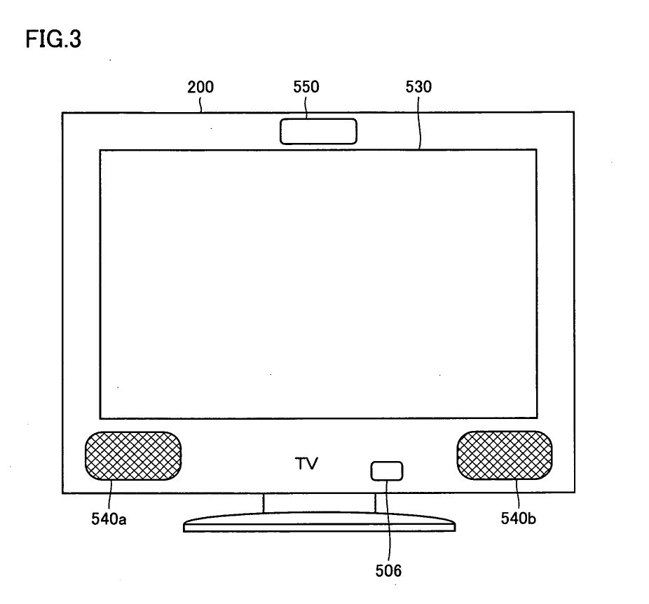

Herein, with reference to FIG. 3, a description is given of the structure of television 200. FIG. 3 is a front view showing television 200. Television 200 comprises camera 550, a display 530, and speakers 540a, 540b. Speakers 540a and 540b can output stereo sound. The positions of speakers 540a and 540b are not limited to those shown in FIG. 3. For example, each speaker may be arranged to a side of a casing of television 200. Further, although camera 550 is set on the central line of the front side of television 200, it may not be set to the center. Camera 550 shoots the object existing within a shootable range. The object includes a viewer of television 200 and remote control terminal 14 that is operated by the viewer. Camera 550 may receive near infrared beams. In this case, preferably, camera 550 may not have an infrared cut-off filter.

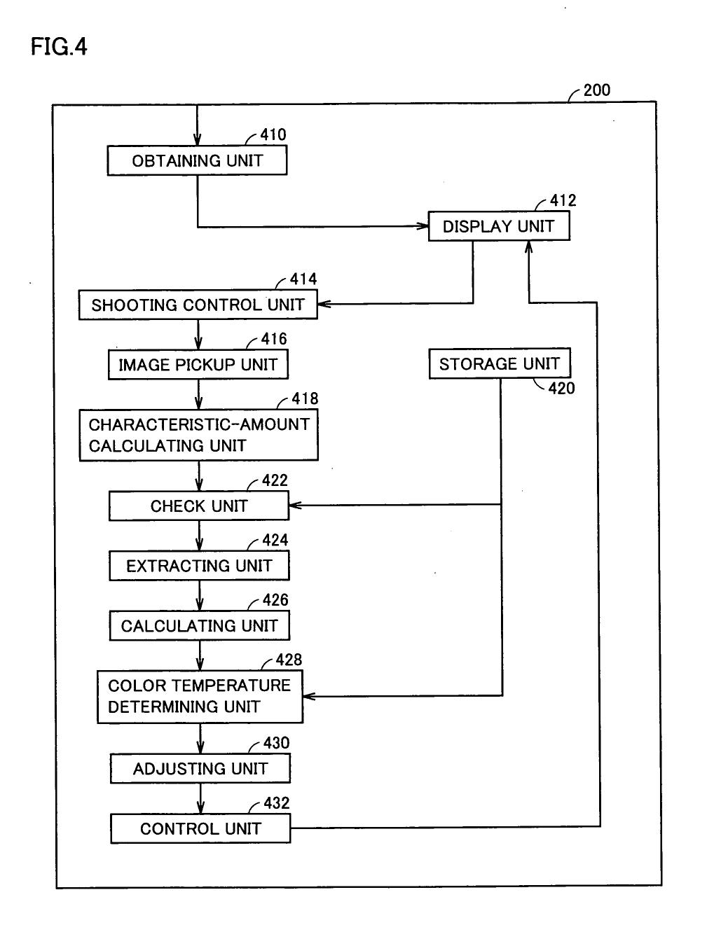

Hereinbelow, with reference to FIG. 4, a further description is given of the structure of television 200. FIG. 4 is a block diagram showing a structure of functions for realizing television 200 according to the present invention. Television 200 mainly comprises an obtaining unit 410, a display unit 412, a shooting control unit 414, an image pickup unit 416, a characteristic-amount calculating unit 418, a check unit 422, an extracting unit 424, a calculating unit 426, a color temperature determining unit 428, an adjusting unit 430, a control unit 432, and a storage unit 420. The components are connected to receive and send signals.

Obtaining unit 410 obtains a video signal for displaying a color image from outside. Obtaining unit 410 is, e.g., a tuner for selecting a TV broadcasting signal, an input interface for receiving an input of a digital video signal, or the like. The tuner may be a digital tuner or an analog tuner. If the analog tuner is used, an analog signal is converted into a digital signal in television 200, and image adjusting processing is executed, which will be described later.

Display unit 412 displays a color image on the basis of the video signal obtained by obtaining unit 410. Display unit 412 is, e.g., a liquid crystal display, an organic electro luminescence (EL) display, a CRT (Cathode Ray Tube) display, or another display device.

Shooting control unit 414 outputs an instruction for shooting the viewer of television 200 on the basis of the display operation of the color image on display unit 412. The instruction is sent to image pickup unit 416. Image pickup unit 416 shoots the object existing within a shootable range that is set in advance on the basis of the instruction, and outputs corresponding image data. The image data is sent to characteristic-amount calculating unit 418. Characteristic-amount calculating unit 418 executes image processing that is prescribed on the basis of the image data, and calculates the characteristics amount of the object. Preferably, characteristic-amount calculating unit 418 executes filtering processing, edge emphasis processing, and other image adjusting processing of the image data.

Storage unit 420 stores data that is input in advance to television 200. Storage unit 420 stores the data that is registered in advance as the viewer of television 200 (data for identifying the viewer and data for controlling the display operation of display unit 412 that is input by the corresponding viewer).

With respect to the viewer whose characteristics amount is calculated by characteristic-amount calculating unit 418 and the viewer registered to storage unit 420, check unit 422 checks to see if the viewer shot by image pickup unit 416 is a viewer registered in advance to television 200. Check unit 422 searches for the characteristics amount calculated by characteristic-amount calculating unit 418 from the characteristics amount stored in storage unit 420, and determines whether or not there is a data index having the same characteristics amount, thereby checking to see if this viewer is registered.

Extracting unit 424 extracts partial image data corresponding to a partial area of the object image on the basis of the image data obtained by image pickup unit 416. The partial area indicates, e.g., an area preset as a target of image data processing within the shootable range of image pickup unit 416. Preferably, extracting unit 424 extracts, as the partial image data, the image corresponding to the top of the viewer that is shot with the shooting operation. In this case, the cloth of the viewer is not included in the image data. Thus, even if a color of the viewer's cloth is similar to a primary color, such as RGB (Red, Green, or Blue), the color adjustment is not influenced by the cloth color.

Calculating unit 426 calculates the total of color elements forming the color image at the partial area with the partial image data extracted by extracting unit 424.

Color temperature determining unit 428 determines the color temperature of the shot image on the basis of the total of color elements calculated by calculating unit 426. Further, color temperature determining unit 428 determines the color temperature displayed on display unit 412 on the basis of the set data stored in storage unit 420. The color temperature is determined by storing, as map data, a corresponding relationship between the total of color elements and the color temperature to storage unit 420 and by then referring to the map data. Preferably, when the total of color elements calculated by calculating unit 426 is below a preset upper limit, color temperature determining unit 428 determines the color temperature. Thus, when the total of color elements is over the upper limit, the color is not adjusted. Thus, it can be prevented that the adjusting processing of the color temperature is not converged.

Adjusting unit 430 adjusts values of the color elements of the image displayed on display unit 412 on the basis of the set data stored in storage unit 420. Incidentally, a broadcasting signal received by television 200 can include a signal for prohibiting the image adjusting processing. For example, for the purpose of copyright protection, control data for prohibiting the change in display color of the color image on the television 200 as a receiving device can be added to a video and audio signal itself (so-called content) and can be then sent. In this case, the television 200 detects the control data after receiving the broadcasting signal, adjusting unit 430 does not change the display color of the video image in response to the detection. Thus, the video image based on the broadcasting signal is reproduced without change.

Control unit 432 controls the video display operation at a display area on display unit 412 on the basis of the values of the color elements adjusted by adjusting unit 430. Specifically, control unit 432 outputs the adjusted values of the color components to display unit 412. Display unit 412 changes an output format of the video signal in accordance with the value.

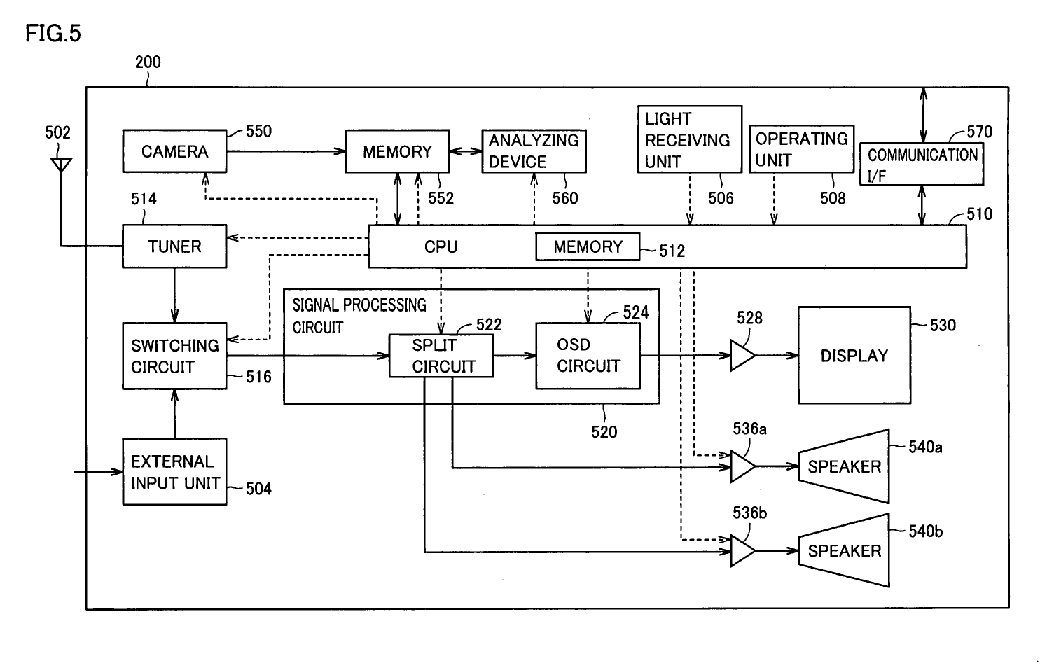

Hereinbelow, with reference to FIG. 5, a description is given of the specific structure of the television according to the embodiment. FIG. 5 is a block diagram showing a hardware structure of television 200.

Television 200 mainly comprises an antenna 502, an external input unit 504, a light receiving unit 506, an operating unit 508, a CPU (Central Processing Unit) 510, a tuner 514, and a switching circuit 516. CPU 510 comprises a memory 512. The broadcasting signal received by antenna 502 is sent to tuner 514. Tuner 514 selects a channel whose selection is instructed on the basis of a control signal output from CPU 510.

External input unit 504 receives the input of the video and audio signal from its outside. For example, external input unit 504 receives an input of a video and audio signal sent from a VCR (Video Cassette Recorder), a DVD (Digital Versatile Disc) player, or another image reproducing device. The video and audio signal is sent from external input unit 504 to switching circuit 516. External input unit 504 may separately receive the video signal and the audio signal and, alternatively, may be obtained by combining cables for sending signals to one cable. Switching circuit 516 selectively outputs a signal output from tuner 514 or a signal output from external input unit 504 on the basis of a switching instruction output from CPU 510.

Television 200 further comprises camera 550, a memory 552, an analyzing device 560, and a communication I/F (Interface) 570. Camera 550 comprises, e.g., a CCD (Charge Coupled Device) solid-state image pickup device.

Memory 552 is, e.g., a flash memory. Camera 550 shoots the object (viewer) on the basis of a shooting instruction output from CPU 510, and sends image data of the object to memory 552. Memory 552 stores the image data in an area specified by a writing instruction output from CPU 510. Analyzing device 560 analyzes the image data obtained by shooting with camera 550 on the basis of the instruction from CPU 510. Analyzing processing will be described later.

Communication I/F 570 is connected to a network (not shown), and communicates data with another information communication device. Incidentally, television 200 may not have a communication I/F. A signal communicated via communication I/F 570 includes the control signal and the video and audio signal.

Referring again to FIG. 5, television 200 comprises a signal processing circuit 520, a driver 528, a display 530, amplifiers 536a and 536b, and speakers 540a and 540b. Signal processing circuit 520 comprises a split circuit 522 and an OSD (On-Screen Display) circuit 524.

A signal output from switching circuit 516 is input to split circuit 522. Split circuit 522 executes processing for splitting the signal into a video signal and an audio signal on the basis of an instruction from CPU 510. The video signal output from split circuit 522 is input to OSD circuit 524. The audio signal output from split circuit 522 is sent to amplifiers 536a and 536b.

OSD circuit 524 generates a signal for displaying an image on display 530 on the basis of an instruction from CPU 510. The image contains, e.g., a channel number or another character information. Further, the character information contains the display operation of the volume level and the display- operation of television 200. The display operation indicating change operation includes up/down operation of volume and change in contrast. Specifically, OSD circuit 524 combines the video signal output from split circuit 522 and the image signal generated on the basis of the data pre-stored in memory 512, and outputs the signal generated by the combination to driver 528.

Driver 528 executes display processing of the image on display 530 on the basis of the signal output from OSD circuit 524. Amplifiers 536a and 536b amplify audio signals output from split circuit 522, and send the resultant signals to speakers 540a and 540b. Speakers 540a and 540b output sound on the basis of the signals.

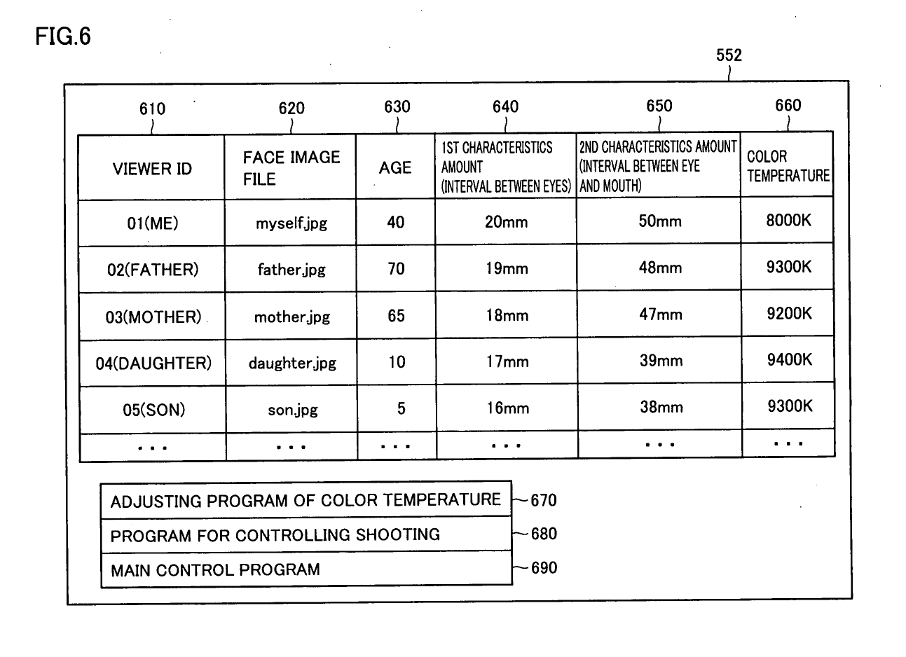

Hereinbelow, with reference to FIG. 6, a description is given of a data structure of television 200. FIG. 6 is a diagram conceptually illustrating one aspect of data storage in memory 552. Memory 552 comprises areas 610 to 660 for storing data and areas 670 to 690 for storing prepared programs.

Information for identifying the viewer (viewer ID) is stored in area 610. A data file of face images obtained by shooting the viewers is stored in area 620. Attribute information (e.g., age) of the viewer is stored in area 630. A first characteristics amount (interval between the eyes) of the face image of the viewer is stored in area 640. Similarly, a second characteristics amount (interval between the eye and the mouth) is stored in area 650. Data for specifying a color temperature of the video image input every viewer is stored in area 660. Data stored in areas 610 to 660 is associated with each other. Thus, other associated data item can be derived by specifying the viewer ID stored in area 610.

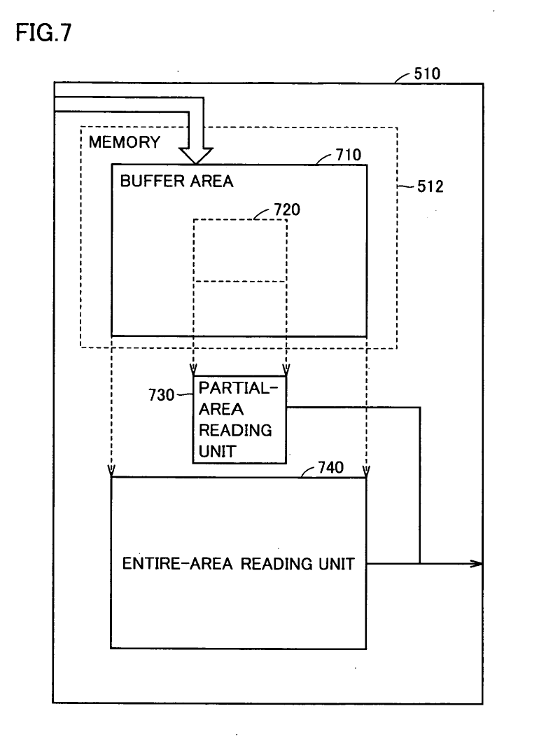

Hereinbelow, with reference to FIG. 7, a description is given of image extracting processing according to this embodiment. FIG. 7 is a diagram conceptually illustrating an example of data processing of the CPU 510.

CPU 510 comprises a buffer area 710 that receives an input of a video signal from camera 550 and stores the signal, an entire-area reading unit 740 that reads the data in accordance with the entire area determined in accordance with a display area on display 530 to buffer area 710, and a partial-area reading unit 730 that reads data stored in a partial area 720 which is determined to buffer area 710 as a partial display area on display 530.

Entire-area reading unit 740 reads signals stored in buffer area 710 at predetermined processing speeds. When display 530 displays the image on the basis of this signal, the entire image of the object obtained by shooting with camera 550 is displayed on the entire display areas on display 530.

Partial-area reading unit 730 reads the signals stored in partial area 720. In this case, the reading speed is faster than a reading speed from the entire area of buffer area 710. That is, the area as a target of reading processing by partial-area reading unit 730 is smaller than the area as a target of reading processing by entire-area reading unit 740. Thus, the signals stored in partial area 720 are read faster than the signal corresponding to the entire area.

As a result, CPU 510 can execute signal reading processing faster than normal image processing on the basis of the video image shot by camera 550. Even if the object is still, the object is shot at the partial area determined in advance in camera 550 and information based on the signal sent from the object, e.g., infrared beams can thus be obtained.

Considering that the output from camera 550 is read from the upper left to the down right pixel by pixel, an area determining unit for specifying an area as a processing target may be provided. The total of color elements is calculated by extracting only the data in the partial area and sequentially adding the color elements. In this case, a buffer memory for image is not necessary and the circuit is therefore simplified.

In many cases, a camera module used for a mobile phone or the like includes an auto white balance (AWB) circuit. Data under intermediate processing in the auto white balance circuit, i.e., the total of color elements are read out, thereby obtaining the total of color elements.

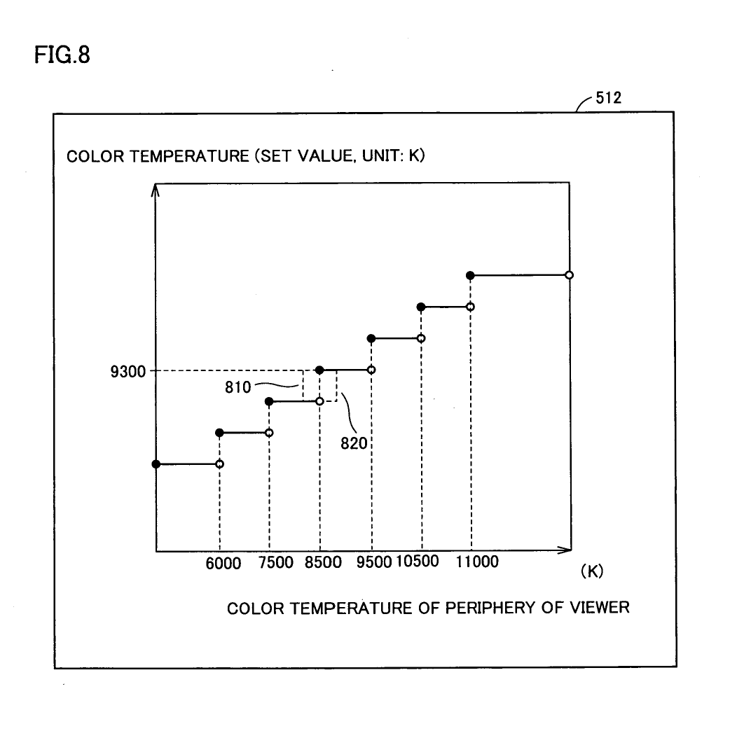

Hereinbelow, with reference to FIG. 8, the color temperature will be described. FIG. 8 is a diagram showing a relationship of a color temperature pre-input as a set value and a color temperature at the setting position of the television 200, specifically, a color temperature near the viewer during the viewing time.

For example, when the color temperature near the viewer, calculated by the viewer shooting, is between 8500K and 9500K, the value of 9300K is set as the color temperature of the video image displayed on television 200.

When the calculated color temperature is between the set values, e.g. between 8500K and 9500K, hysteresis may be provided so as to prevent the sharp change of the set value due to the change in the calculated color temperature. Specifically, when the calculated color temperature is reduced from 8500K by several hundreds color temperatures (K), the used set value may be changed from 9300K to 8500K (hysteresis 810). On the other hand, when the calculated color temperature is increased from 8500K by several hundreds color temperatures (K), the used set value may be changed from 8500K to 9300K (hysteresis 820).

A relationship shown in FIG. 8 is realized by displaying a screen for receiving the input of the set value and storing in the memory the input from the viewer who desires the input of the set value. In this case, a value of the color temperature may be directly input as the set value. Alternatively, a color image of a sample corresponding to the set value may be displayed on television 200 so as to display the color image in accordance with the increase or decrease in set value and the viewer may check the color corresponding to the set value.

Further, in place of inputting the set value, a plurality of functions for determining the change in color may be prepared and names indicating the features of the display color may be added to the functions (e.g., “sharp video image” or “muted video image”, etc.), the name may be selected by the viewer, and the function corresponding to the selected name may be associated with the viewer, thereby storing the function and the name to memory 552.

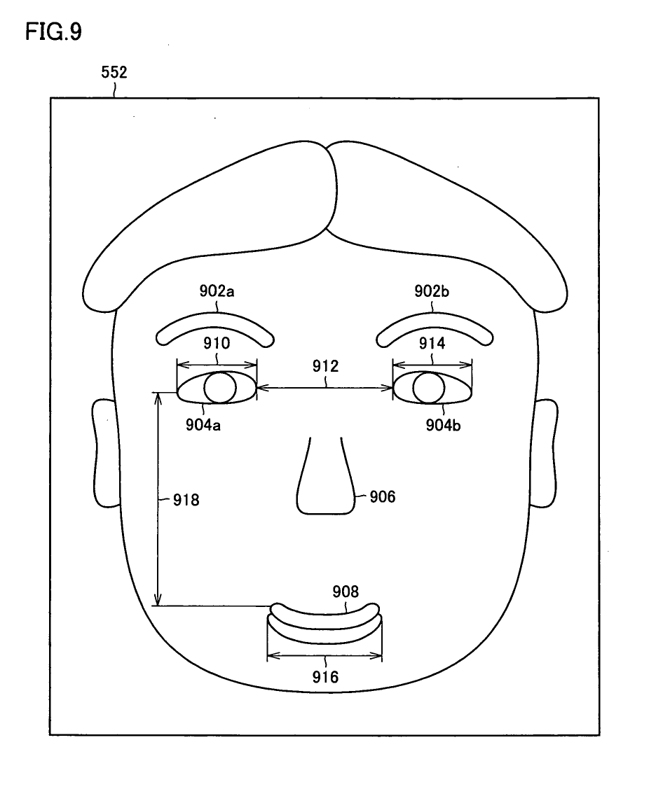

Herein, with reference to FIG. 9, a description is given of extracting processing of face image data according to this embodiment. FIG. 9 is a diagram conceptually the face image stored in memory 552.

Shooting processing is normally executed while the object is in front of display 530 of television 200. Data generated by the shooting processing is stored in memory 552. The face of the object includes a skin color part and a non-skin-color part. For example, the hair, eyebrow, or eye is black or brawn, that is, different from the skin color (e.g., flesh-colored). With respect to the image of the object, the image data is subjected to binarizing processing or grayscale processing, thereby generating images with varied grayscales.

That is, as shown in FIG. 9, eyebrows 902a and 902b, eyes 904a and 904b, a nose 906, and a mouth 908 are extracted. If an area in memory 552 is specified in advance, e.g., an interval 912 between the eyes, eye lengths 910 and 914, a width 916 of the mouth, and an interval 918 between the tail of eyes and the center of the mouth are calculated as relative distances. The distances are expressed by the number of pixels. Values of intervals 912 and 918 are stored in areas reserved in memory 552 as information in the right and left directions and information in the up and down directions. Thus, it can be easily specified at which position the object is in the image generated by the shooting with camera 550.

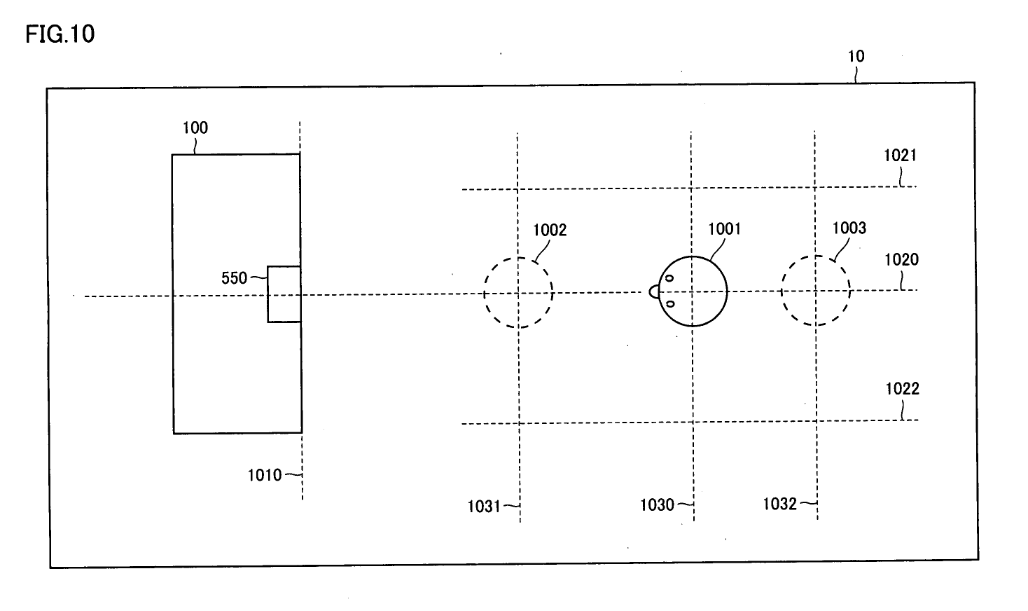

Hereinbelow, with reference to FIG. 10, a description is given of a ‘standard position’ upon using television 200 according to the embodiment. FIG. 10 is a top view showing a room in which television 200 is set. Viewer 1001 views the television 200 in room 10. Viewer 1001 is at the ‘standard position’ relative to television 200. Herein, the standard position means a predetermined position relative to television 200. This position is specified by a distance from television 200 and a distance from the axis passing through the center of television 200.

In an example shown in FIG. 10, the standard position is an intersection between a dotted line 1020 and a dotted line 1030. Dotted line 1030 corresponds to the position apart from dotted line 1010 corresponding to the reference position of television 200 by a predetermined distance. The distance may be prescribed as an integral multiple of the scale (so-called inch size) of the display area on television 200. Alternatively, the distance may include the width of the distance, e.g., n to n+1 multiples of the display area. Dotted line 1020 corresponds to a central line of television 200, e.g., a line vertically intersecting to display 530.

In this state, viewer 1001 performs initial registration to television 200. That is, viewer 1001 is shot by camera 550, and analyzing device 560 recognizes the face image of viewer 1001 and calculates the characteristics amount. As a consequence thereof, viewer 1001 is normally identified, the characteristics amount is then registered to television 200. Each time when viewer 1001 views television 200, camera 550 shoots viewer 1001. Therefore, the additionally-calculated characteristics amount can be compared with the already-stored characteristics amount.

It can be considered that viewer 1001 can view television 200 at the position near television 200, instead of the standard position. For example, viewer 1001 can view television 200 at position 1002 shown by a dotted line 1031. On the other hand, viewer 1001 can view television 200 at a position 1003 shown by a dotted line 1032, apart from television 200. In this case, the distance between viewer 1001 and camera 550 is reduced or is increased. According to this embodiment, a ratio of characteristics amounts is used for viewer identification. For example, a ratio of an interval between the eyes of the viewer to an interval between the eye and the mouth is used for the viewer identification. In this case, if the viewer is a single one, although the distances from camera 550 are different, the ratios are the same. Such erroneous identification that viewer 1001 is another viewer can be prevented. Therefore, the subsequent operation of television 200 can be controlled in accordance with viewer 1001.

Further, the viewer can view television 200 at the position displaced from central axis 1020. For example, a plurality of viewers can view a video image on television 200. Specifically, another viewer can view television 200 at positions shown by dotted lines 1021 and 1022. In this case, the ratios of the characteristics amount are not greatly different from the ratio of the pre-registered characteristics amounts. As a consequence, the amount of the difference is set in advance as an error, thereby accurately identifying the single viewer.

Incidentally, the position different from the standard position is not limited to that shown in FIG. 10. A visible position of the video image on television 200 in room 10 can be different from the standard position.

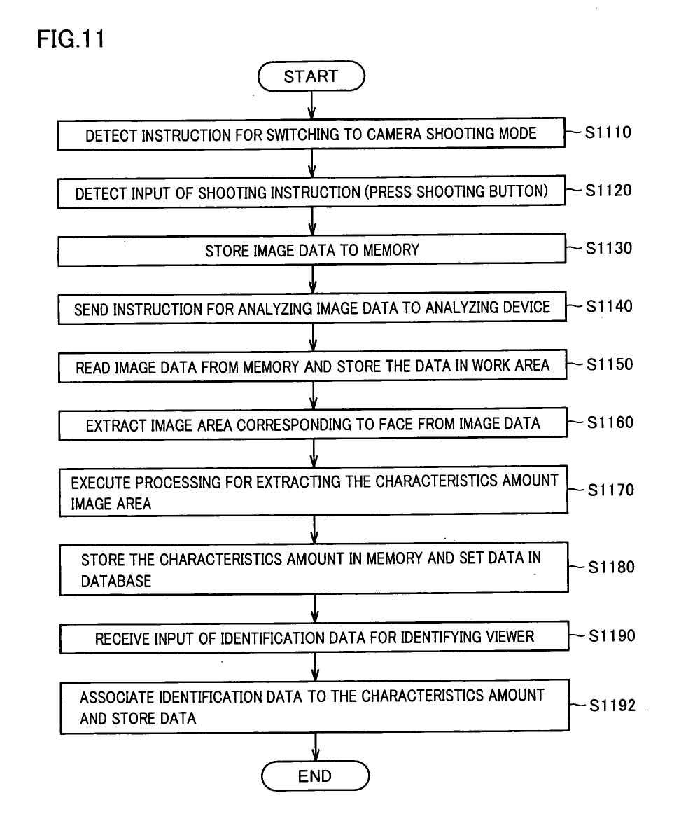

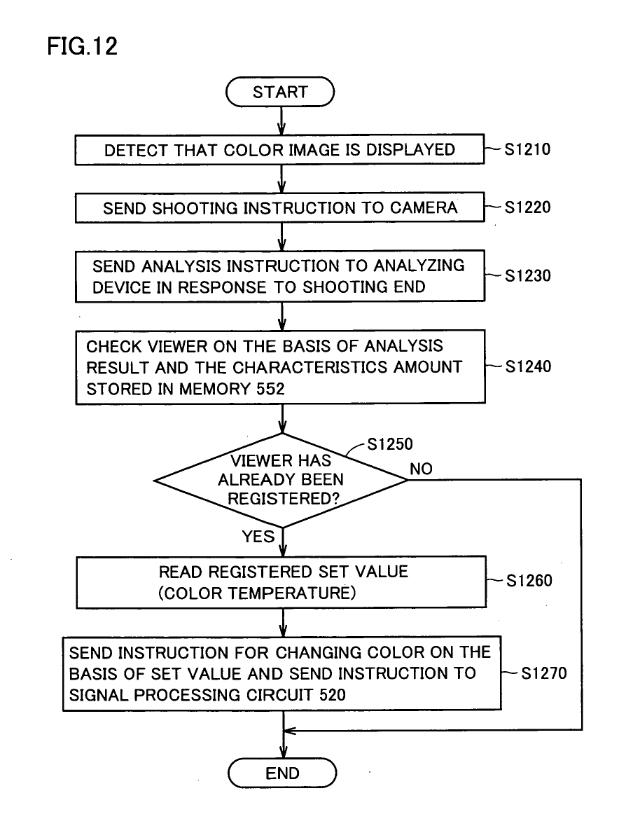

Hereinbelow, with reference to FIGS. 11 and 12, a description is given of a control structure of television 200. FIG. 11 is a flowchart showing a procedure of processes executed by CPU 510 for first identifying the viewer.

In step S1110, CPU 510 detects an instruction for switching an operation mode of television 200 to a shooting mode of camera 550 on the basis of reception of a signal sent by a remote control terminal (not shown), input via light receiving unit 506. In step S820, CPU 510 detects an instruction for pressing a shooting button (not shown) of camera 550 on the basis of the shooting instruction signal from the remote control terminal, received by light receiving unit 506. CPU 510 outputs an instruction for shooting the object in the shooting mode preset to camera 550. The shooting mode includes a stop status, a shutter speed, and the like. Camera 550 executes the shooting processing of the object in response to the instruction. After the shooting processing, camera 550 outputs the image data. The output data is stored in an area reserved in memory 552.

In step S1130, CPU 510 stores data sent from camera 550 to memory 552 in the area that is reserved in advance in memory 552. Instep S1140, CPU 510 issues an instruction for executing analysis processing prescribed with the data stored in memory 552 to analyzing device 560. This instruction is realized by sending a command indicating this processing from CPU 510 to analyzing device 560.

In step S1150, analyzing device 560 reads the image data from memory 552 on the basis of the instruction, and stores the image data in a work area in a RAM (Random Access Memory) (not shown) that is provided for analyzing device 560. In step S1160, analyzing device 560 extracts the face image corresponding to the face of the viewer from the data. Processing for extraction is realized with well-known image processing.

In step S1170, analyzing device 560 executes processing for calculating the characteristics amount of the image area. The calculated characteristics amount corresponds to an item that is designated in advance by CPU 510. In step S1180, analyzing device 560 stores the calculated characteristics amount in the area that is reserved in advance in memory 552. As a consequence, the identifying processing of the viewer sitting at the standard position relative to television 200 ends, the data for specifying the viewer is stored in memory 552 (areas 620, 640, and 650 in FIG. 6). Further, the viewer inputs a viewer ID for identifying the viewer, and the data is stored in memory 552 (area 610). When the viewer inputs the attribute information, the attribute information is also stored in memory 552 (area 630). In addition, when the viewer sets the adjustment of the video image displayed on display 530, the color temperature calculated by the setting is stored to memory 552 (area 660). Thus, the preference of the video image of the viewer is reflected to television 200.

Hereinbelow, with reference to FIG. 12, a description is further given of the control structure of television 200. FIG. 12 is a flowchart showing a procedure of processes executed by CPU 510 for displaying the video image in accordance with the viewer.

In step S1210, CPU 510 detects the display operation of a color image on display 530. Instep S1220, CPU 510 sends the shooting instruction to camera 550. Camera 550 shoots the object existing within a predetermined shootable range on the basis of a preset shooting mode in response to the instruction. The data generated by the shooting operation is stored in memory 552. When the shooting operation by camera 550 ends, camera 550 sends a signal notifying the fact to CPU 510.

In step S1230, CPU 510 sends an instruction for analyzing the image data obtained in response to the reception of the instruction indicating the shooting end to analyzing device 560. Analyzing device 560 executes the prescribed image analysis processing with the data stored in memory 552 on the basis of the instruction. The result of analysis processing is stored in an area reserved in memory 552.

In step S1240, CPU 510 checks to see if the viewer obtained this time is the viewer that is registered in advance on the basis of the analysis result and the characteristics amount (the characteristics amount obtained upon registering the viewer) prestored in memory 552. Instep S1250, CPU 510 checks whether the viewer is a viewer that has already been registered on the basis of the result of check process in step S1240. If CPU 510 determines that the viewer has already been registered (YES in step S1250), the processing advances to step S1260. If CPU 510 determines that the viewer has not already been registered (NO in step S1250), the processing ends. In this case, television 200 continues the display operation of the color image on the basis of the prescribed set value.

In step S1260, CPU 510 reads the set value (color temperature) that is registered in advance from memory 552. Instep S1270, CPU 510 sends an instruction for changing the color to signal processing circuit 520 on the basis of the read set value. Signal processing circuit 520 changes the display color of the color image signal in accordance with the instruction. The changed signal is output from signal processing circuit 520, and display 530 displays the color image on the basis of the signal. The above-displayed color image is a video image that reflects the setting by the viewer.

As described above, television 200 according to this embodiment stores the characteristics amount in advance as data for specifying the viewer. A video display manner (grayscale of the display color) is associated with the characteristics amount as the set value indicating the preference of the viewer. Television 200 has the camera. Upon displaying the color image, television 200 shoots the viewer in the video image, obtains the image of the viewer, and calculates the characteristics amount of the viewer. When the viewer who views the color image is the viewer that is registered in advance in television 200 and the set value of the viewer exists, television 200 adjusts and displays the color image on the basis of the set value. Thus, the color image can be displayed in accordance with the viewer.

According to this embodiment, television 200 includes camera 550. Alternatively, a camera that can be externally connected to television 200 may be used. Further, analyzing device 560 that analyzes the image shot by camera 550 may be externally connected to television 200. In this case, the processing for identifying the viewer and the processing for outputting the identifying result are performed by an analyzing device that is externally connected the television. The television may adjust or may not adjust the display operation of the color image, depending on the identifying result depending on the viewers. As a consequence, the existing color television can perform display processing of colors depending on the viewers.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A color image display apparatus comprising:
a tuner that obtains a video signal for displaying a color image;
a display that displays the color image at a display area on the basis of the video signal;
a camera that shoots an object and obtains image data corresponding to an image of the object;
a memory that stores a first characteristics amount obtained in advance for a first viewer of the color image display apparatus, and a set value input in advance so as to display a color image to the first viewer, the first characteristics amount being associated with the set value;
a shooting control circuit that causes the camera to execute shooting operation on the basis of the video image displayed at the display area;
a characteristic-amount calculating circuit that performs image analysis processing preset to a second viewer's image data obtained on the basis of the shooting operation to calculate the second viewer's characteristics amount;
a determining circuit that determines whether or not the second viewer is the first viewer by comparing the first viewer's characteristics amount with the second viewer's characteristics amount;
an extracting circuit that extracts partial image data corresponding to a partial area within a shootable range of the camera from the image data obtained by the camera;
a calculating circuit that calculates the total of color components forming an image corresponding to the partial image on the basis of the partial image data;
a color temperature determining circuit that determines a color temperature on the basis of the total of color elements; and
an element changing circuit that changes color elements forming a video image displayed at the display area on the basis of the color temperature and the set value.

2. A color image display apparatus comprising:
an obtaining unit that obtains a video signal for displaying a color image;
a display unit that displays the color image at a display area on the basis of the video image signal;
an image pickup unit that shoots an object and obtains image data corresponding to an image of the object;
a storage unit that stores specific data prepared in advance so as to specify a first viewer of the color image display apparatus and a set value input in advance so as to display a color image of the first viewer, the specific data being associated with the set value;
an image obtaining unit that obtains an image of a second viewer who views the video image on the basis of the video image displayed at the display area;
a determining unit that determines whether or not the second viewer is the first viewer on the basis of the specific data and the image of the second viewer; and
a control unit that controls display of the video image at the display area by adjusting a display color of the video image displayed at the display area on the basis of the set value corresponding to the first viewer, when the determining unit determines that the second viewer is the first viewer.

3. The color image display apparatus according to claim 2, wherein the specific data includes a characteristic amount obtained in advance for a face image of the first viewer,
the image obtaining unit comprises:
a shooting control unit that causes the image pickup unit to shoot the object on the basis of display operation of the video image at the display area; and
a characteristic-amount calculating unit that performs image analysis processing preset to the second viewer's image data, obtained on the basis of the shooting operation to calculate the second viewer's characteristics amount, and
the determining unit determines whether or not the second viewer is the first viewer by comparing the first viewer's characteristics amount with the second viewer's characteristics amount.

4. The color image display apparatus according to claim 2, wherein the control unit comprises:
an extracting unit that extracts partial image data corresponding to a partial area within a shootable range of the image pickup unit on the basis of the image data obtained by the image pickup unit; and
a display color adjusting unit that adjusts a display color of the video image displayed at the display area on the basis of the partial image data.

5. The color image display apparatus according to claim 4, wherein the display color adjusting unit comprises:
a calculating unit that calculates the total of color elements forming an image corresponding to the partial area on the basis of the partial image data;
a color temperature determining unit that determines a color temperature on the basis of the total of color elements; and
an element changing unit that changes the color elements of the video image on the basis of the color temperature and the set value.

6. The color image display apparatus according to claim 5, wherein the color temperature determining unit determines the color temperature, when the total of color elements calculated by the calculating unit is lower than a preset upper limit.

7. The color image display apparatus according to claim 4, wherein the extracting unit extracts an image corresponding to the top of the viewer shot by the shooting operation as the partial image data.

8. The color image display apparatus according to claim 2, wherein the obtaining unit comprises a station selecting unit that selects a television broadcasting signal.

9. The color image display apparatus according to claim 2, wherein the obtaining unit comprises an external input unit that receives an input of the video signal from outside.

10. The color image display apparatus according to claim 9, wherein the external input unit receives the input of the video signal via a network.

11. The color image display apparatus according to claim 2, wherein the video signal includes control data for prohibiting the change of display operation of a color image,
the color image display apparatus further comprises a detecting unit that detects the control data from the video signal, and
the control unit prohibits adjustment of a display color of the video image when the control data is detected.

12. A color image display apparatus comprising:
an interface that obtains a video signal for displaying a color image;
a display device that displays the color image in the display area on the basis of the video signal;
a camera that shoots an object and obtains image data corresponding to an image of the object;
a memory that stores specific data prepared in advance so as to specify a first viewer of the color image display apparatus, a set value input in advance so as to display a color image to the first viewer, and an instruction sequence, the specific data being associated with the set value; and
a processor that executes the instruction sequence,
wherein the instruction sequence comprises:
an image obtaining step of obtaining an image of a second viewer who views the video image based on that the video image is displayed at the display area;
a determining step that determines whether or not the second viewer is the first viewer on the basis of the specific data and the image of the second viewer; and
a control step of controlling the display operation of the video image at the display area by adjusting a display color of the video image displayed at the display area on the basis of the set value associated with the first viewer, when it is determined that the second viewer is the first viewer.

13. The color image display apparatus according to claim 12, wherein the specific data includes characteristics amount obtained in advance for a face image of the first viewer,
the image obtaining step comprises:
a step of causing the image pickup unit to shoot an image based on that the video image is displayed at the display image; and
a step of performing image analysis processing preset to image data of the second viewer, obtained on the basis of the shooting operation, and calculating the second viewer's characteristics amount, and
the determining step determines whether or not the second viewer is the first viewer by comparing the first viewer's characteristics amount with the second viewer's characteristics amount.

14. The color image display apparatus according to claim 12, wherein the control step comprises:
an extracting step of extracting partial image data corresponding to a partial area within a shootable range of the camera on the basis of the image data obtained by the camera; and
an adjusting step of adjusting a display color of the video image displayed at the display area on the basis of the partial image data.

15. The color image display apparatus according to claim 14, wherein the adjusting step comprises:
a calculating step of calculating the total of color elements forming an image corresponding to the partial area on the basis of the partial image data;
a determining step of determining a color temperature on the basis of the total of color elements; and
a changing step of changing color elements of the video image on the basis of the color temperature and the set value.

16. The color image display apparatus according to claim 15, wherein the determining step determines the color temperature, when the total of color elements calculated by the calculating step is lower than a preset upper limit.

17. The color image display apparatus according to claim 14, wherein the extracting step extracts an image corresponding to the top of the viewer, shot by the shooting operation, as the partial image data.

18. The color image display apparatus according to claim 12, wherein the interface comprises a tuner that selects a television broadcasting signal.

19. The color image display apparatus according to claim 12, wherein the interface comprises an external input unit that externally receives an input of the video signal.

20. The color image display apparatus according to claim 19, wherein the external input unit receives the input of the video signal via a network.
